(19) United States
(12) Patent Application Publication
(10) Pub. No.: US 2026/0153984 A1
(43) Pub. Date: Jun. 4, 2026

(54) ELECTRONIC DEVICE, METHOD FOR CONTROLLING ELECTRONIC DEVICE, AND STORAGE MEDIUM

(71) Applicant: CASIO COMPUTER CO., LTD., Tokyo (JP)

(72) Inventors: Takumi KONISHI, Tokyo (JP); Masanori ISHIHARA, Tokyo (JP)

(21) Appl. No.: 19/404,636

(22) Filed: Dec. 1, 2025

(30) Foreign Application Priority Data
Dec. 2, 2024 (JP) 2024-209231

(51) Int. Cl. G06F 3/0488; G04G 9/00; G04G 21/08; G06F 3/02; G06F 3/044; G06F 3/0482

(52) U.S. Cl. CPC G06F 3/0488; G04G 9/007; G04G 21/08; G06F 3/02; G06F 3/044; G06F 3/0482

(57) ABSTRACT

An electronic device includes: a display; an operation button that detects a press operation; a touch sensor that detects a touch operation; and a processor. When the processor causes the display to display a screen, the processor: acquires setting information on an operation mode that has been associated with the screen in advance; when the acquired setting information is first setting information corresponding to a first mode in which the processor does not receive an operation via the touch sensor but receives an operation via the operation button, operates the electronic device in the first mode; and when the acquired setting information is second setting information corresponding to a second mode in which the processor receives the operation via the touch sensor, operates the electronic device in the second mode.

### REFERENCE TO RELATED APPLICATIONS

This application claims priority and benefit of Japanese Patent Application No. 2024-209231, filed on Dec. 2, 2024. The specification, claims, and drawings of Japanese Patent Application No. 2024-209231 are incorporated herein by reference in their entirety.

### TECHNICAL FIELD

The present disclosure relates to an electronic device, a method for controlling an electronic device, and a storage medium.

### DESCRIPTION OF RELATED ART

Conventionally, for an electronic device including an operation button that detects a press operation and a touch sensor that detects a touch operation, a technique is known that switches between receiving an operation via the operation button and receiving an operation via the touch sensor according to the surrounding environment (e.g., JP 2017-146981A).

### SUMMARY OF THE INVENTION

An electronic device according to the present disclosure comprises: a display; an operation button that detects a press operation; a touch sensor that detects a touch operation; and a processor, wherein when the processor causes the display to display a screen, the processor: acquires setting information on an operation mode that has been associated with the screen in advance; when the acquired setting information is first setting information corresponding to a first mode in which the processor does not receive an operation via the touch sensor but receives an operation via the operation button, operates the electronic device in the first mode; and when the acquired setting information is second setting information corresponding to a second mode in which the processor receives the operation via the touch sensor, operates the electronic device in the second mode.

### BRIEF DESCRIPTION OF DRAWINGS

In the drawings:

FIG. 1 is a front view of an electronic timepiece;

FIG. 2 is a side view of the electronic timepiece;

FIG. 3 is a block diagram illustrating a functional configuration of the electronic timepiece;

FIG. 4 is a diagram illustrating a slide operation performed on a touch sensor;

FIG. 5 is a diagram illustrating contents of screen setting data;

FIG. 6 is a diagram illustrating a setting menu screen;

FIG. 7 is a diagram illustrating a world time selection screen;

FIG. 8 is a diagram illustrating a world time confirmation screen;

FIG. 9 is a diagram illustrating another example of the world time confirmation screen; and

FIG. 10 is a flowchart illustrating an operation procedure of an operation mode control process.

### DETAILED DESCRIPTION

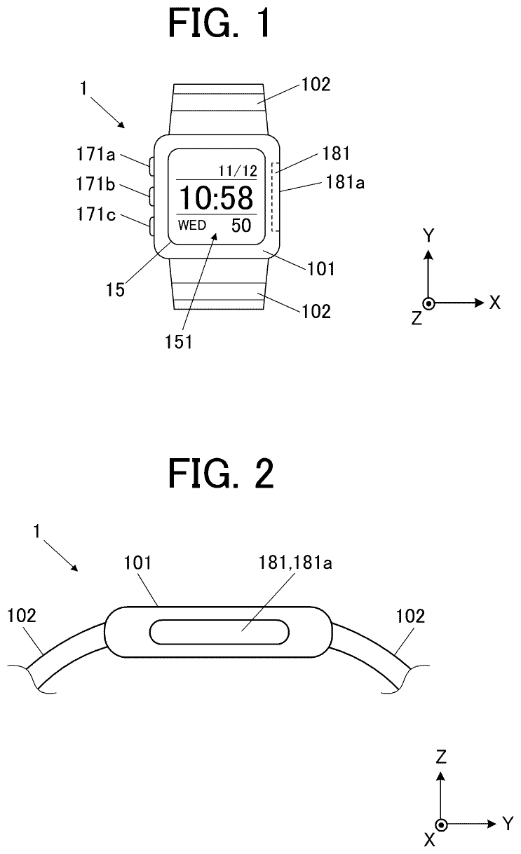

Hereinafter, one or more embodiments according to the present disclosure will be described with reference to the drawings. As illustrated in FIG. 1, an electronic timepiece 1 (electronic device) includes a housing 101 in which a display 15 and the like are housed, and two bands 102 attached to the housing 101. The electronic timepiece 1 is a wristwatch used by being worn on a wrist of a user by wrapping the bands 102 around the wrist. In the following, a direction parallel to the display surface of the display 15 and to the right as seen by the user facing the display 15 is defined as a +X direction. A direction parallel to the display surface of the display 15 and upward as seen by the user facing the display 15 and perpendicular to the X direction is defined as a +Y direction. The normal direction of the display surface of the display 15 is defined as a +Z direction. The housing 101 is a rectangle with rounded corners when viewed from the +Z direction. A touch sensor 181 that detects a touch operation by an operation means such as a finger of the user is provided on the side of the housing 101 in the +X direction. In the present embodiment, the operation means is assumed to be the user's finger. As illustrated in FIG. 2, the touch sensor 181 has an operation surface 181a that extends in the Y direction as viewed from the +X direction. Three operation buttons 171a to 171c for detecting a press operation are provided on the side of the housing 101 in the-X direction. Hereinafter, the term “operation button 171” will be used when referring to any one of the operation buttons 171a to 171c. The number of operation buttons 171 is not limited to three but may be two or less or four or more. The operation button 171 may be provided on the side of the housing 101 in the +X direction, excluding a region where the touch sensor 181 is disposed. The shape of the housing 101 is not limited to a substantially rectangular shape. For example, the housing 101 may be substantially circular or the like when viewed from the +Z direction, and the operation surface 181a of the touch sensor 181 may be curved according to the shape of the housing 101.

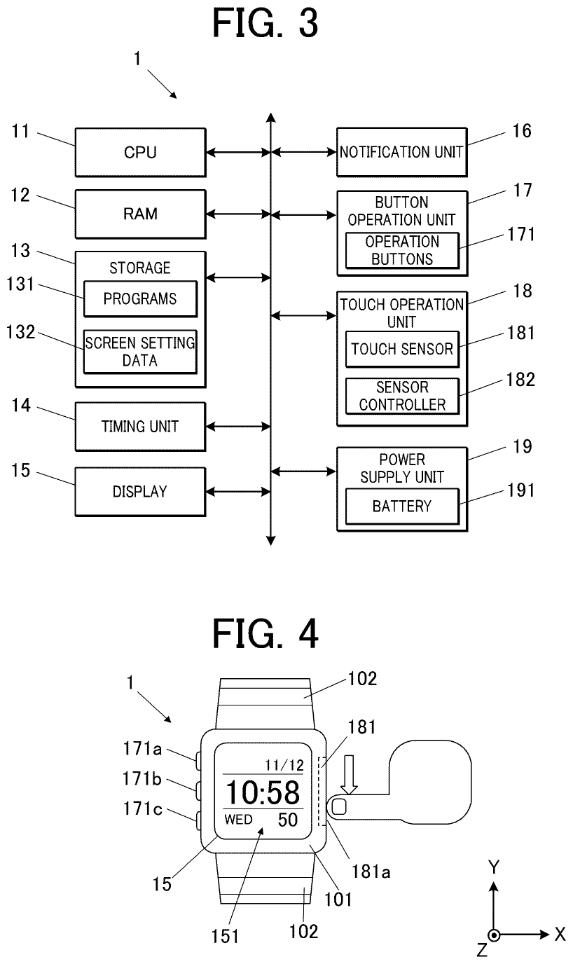

As illustrated in FIG. 3, the electronic timepiece 1 includes a central processing unit (CPU) (controller, control means) 11, a random-access memory (RAM) 12, a storage 13, a timing unit 14, the display 15, a notification unit 16, button operation unit 17, touch operation unit 18 and power supply unit 19. The components of the electronic timepiece 1 are coupled to each other via a data transmission path such as a bus.

The CPU 11 is a processor that reads and executes programs 131 stored in the storage 13 to execute various arithmetic processing, thereby controlling the operation of the electronic timepiece 1. The electronic timepiece 1 may include a plurality of processors (e.g., a plurality of CPUs), and the plurality of processors may execute a plurality of processes executed by the CPU 11 according to the present embodiment. In this case, the controller includes the plurality of processors. In addition, the plurality of processors may be involved in a common process, or the plurality of processors may independently execute different processes in parallel. The RAM 12 provides a working memory space for the CPU 11 and stores temporary data. The storage 13 is a non-transitory storage medium readable by the CPU 11 serving as a computer and stores the programs 131 and various data. The storage 13 includes, for example, a nonvolatile memory such as a flash memory. Each of the programs 131 is stored in the storage 13 in the form of a computer-readable program code. The data stored in the storage 13 includes screen setting data 132, and the like. The contents of the screen setting data 132 are described below. The timing unit 14 includes an oscillation circuit, a division circuit, and a timing circuit, and the like. The timing unit 14 counts and holds the current date and time by dividing a clock signal generated by the oscillation circuit by the division circuit and counting the divided signal by the timing circuit.

The display 15 includes a display panel, such as a liquid crystal panel, capable of dot matrix display, and a drive circuit for the display panel. The display 15 displays various screens according to image data and control signals transmitted from the CPU 11, in addition to a home screen 151 illustrated in FIG. 1. On the home screen 151, information such as the current time, date, and day of the week, which are counted and held by the timing unit 14, is displayed. The notification unit 16 includes a piezoelectric speaker and outputs a predetermined notification sound at a timing and in a sound pattern according to a control signal transmitted from the CPU 11. The method of notification by the notification unit 16 is not limited to the output of a notification sound by the piezoelectric speaker. For example, the notification unit 16 may include a vibrator and perform the notification by vibration of the vibrator. The notification unit 16 may include a light emitter and perform the notification by light emission from the light emitter.

The button operation unit 17 includes a plurality of operation buttons 171a to 171c. The button operation unit 17 outputs an operation signal that includes information identifying the operation button 171 that has been pressed to the CPU 11. The button operation unit 17 may include other operation means such as a crown in addition to the operation buttons 171.

The touch operation unit 18 includes the touch sensor 181 and a sensor controller 182 that performs processing related to the detection of a finger using the touch sensor 181. The touch operation unit 18 detects the presence or absence of contact (touch) of a finger with the operation surface 181a and a contact position (touch position) and outputs an operation signal including information on the detection results to the CPU 11. The touch sensor 181 is a capacitive sensor. The touch sensor 181 includes a protective layer constituting the operation surface 181a and electrodes for detecting capacitance. The electrodes are disposed inside the housing 101 along the protective layer. The touch sensor 181 is a self-capacitive sensor that detects contact of the user's finger with the operation surface 181A based on a change in capacitance in response to the contact of the finger with the operation surface 181A. In detail, the touch sensor 181 includes a plurality of electrodes (not shown) arrayed in the Y direction. The sensor controller 182 detects the capacitance between each of the plurality of electrodes and the finger. The sensor controller 182 detects contact of a finger with the operation surface 181a when the capacitance between any of the plurality of electrodes and the finger increases to a predetermined threshold or more in response to the approach or contact of the finger. The sensor controller 182 identifies the contact position of the finger based on the position of the electrode whose capacitance has become equal to or larger than the threshold among the plurality of electrodes. The sensor controller 182 transmits an operation signal including information on the presence or absence of the contact and the detection results of the contact position to the CPU 11. According to the touch operation unit 18 having such a configuration, it is possible to detect a tap operation in which a finger is touched against the operation surface 181a and released on the spot, a long-press operation in which a finger is continuously touched against the operation surface 181a, a slide operation in which the touch position is slid on the operation surface 181a as illustrated in FIG. 4, and the like. Note that the value of the capacitance itself may not be used to detect the contact of the finger, and a value corresponding to the capacitance may be used. In this case, it is only required that the threshold is converted to the value corresponding to the capacitance. The CPU 11 may execute at least a portion of the processing executed by the sensor controller 182 of the touch sensor 181. Note that the touch sensor 181 is not limited to a self-capacitive sensor and may be a mutual capacitive sensor.

The power supply unit 19 includes a battery 191 and a power controller 192. The power supply unit 19 outputs power supplied from the battery 191 to the various components of the electronic timepiece 1 at a predetermined operating voltage. The battery 191 may be a primary battery, such as a button cell, or a rechargeable secondary battery, such as a lithium-ion battery. The power controller 192 detects the remaining amount of power stored in the battery 191 and outputs the detected amount to the CPU 11 in accordance with a control signal transmitted from the CPU 11. The power controller 192 may be capable of switching between supplying and not supplying power to a specific component (e.g., the touch operation unit 18 or the button operation unit 17) in accordance with a control signal transmitted from the CPU 11.

Next, an operation of the electronic timepiece 1 will be described. The CPU 11 of the electronic timepiece 1 can operate the electronic timepiece 1 in a button operation mode (first mode) and a touch operation mode (second mode). The button operation mode and the touch operation mode are different from each other in a method for receiving a user operation. The button operation mode is an operation mode in which an operation via the touch sensor 181 is not received but an operation via the operation buttons 171 is received. On the other hand, the touch operation mode is an operation mode in which an operation via the touch sensor 181 is received and an operation via the operation buttons 171 is not received. However, in the touch operation mode, an operation via the operation buttons 171 may also be received.

The electronic timepiece 1 displays a plurality of screens on the display 15. Among these screens, some are better suited for a user operation via the operation buttons 171 (hereinafter referred to as “first screens”), while others are better suited for a user operation via the touch sensor 181 (hereinafter referred to as “second screens”). Examples of the first screens that are better suited for a user operation via the operation buttons 171 include a screen with few selectable options. This is because when there are few options, the number of times that the button operation unit 17 needs to be pressed to change the currently selected option is reduced. Other examples of the first screens include a screen for making an important decision such as changing settings that have a large impact on the operation of the electronic timepiece 1 or deleting data. The touch sensor 181 has uncertainties, such as a user touching the touch sensor 181 unintentionally or the touch sensor 181 failing to respond despite being touched. In contrast, the operation buttons 171 reliably perform the desired operation compared to the touch sensor 181. Therefore, the operation buttons 171 are more suitable for a screen on which an important decision is made, as the operation buttons 171 are less prone to an erroneous operation. The home screen 151 is another example of the first screens. On the home screen 151 that displays the time, it is preferable to prevent the screen from being changed in response to unintended contact with the touch sensor 181. Therefore, the button operation mode in which an operation via the touch sensor 181 is not received is more suitable for the home screen 151. On the other hand, examples of the second screens on which an operation via the touch sensor 181 is more suitable include a screen with many options and a screen that allows scrolling up and down. This is because using the operation buttons 171 on such a screen requires a large number of press operations to select a desired option or to scroll the screen to a desired position, which is cumbersome.

Therefore, the CPU 11 according to the present embodiment operates the electronic timepiece 1 in the button operation mode when the first screen is displayed on the display 15 and operates the electronic timepiece 1 in the touch operation mode when the second screen is displayed on the display 15. To enable such an operation, as illustrated in FIG. 5, in the screen setting data 132, either first setting information 21 corresponding to the button operation mode or second setting information 22 corresponding to the touch operation mode is stored in advance in association with each of the plurality of screens that can be displayed on the display 15. In FIG. 5, the names of the corresponding operation modes are shown as the first setting information 21 and the second setting information 22. However, the actual first setting information 21 and the second setting information 22 may be, for example, Boolean values (either “0” or “1”). In the example illustrated in FIG. 5, the first setting information 21 is associated with the home screen 151 and a world time confirmation screen 154, and the second setting information 22 is associated with a setting menu screen 152, a world time selection screen 153, and an alarm setting screen 155. The setting information associated with each screen may be changed by a user operation. When displaying a screen on the display 15, the CPU 11 refers to the screen setting data 132 and acquires the setting information, i.e., the first setting information 21 or the second setting information 22, that has been associated with the screen in advance. When the CPU 11 acquires the first setting information 21, the CPU 11 operates the electronic timepiece 1 in the button operation mode when displaying the screen. When the CPU 11 acquires the second setting information 22, the CPU 11 operates the electronic timepiece 1 in the touch operation mode when displaying the screen. Specifically, as described above, in the button operation mode, the CPU 11 does not receive an operation via the touch sensor 181, but receives an operation via the operation buttons 171. In the touch operation mode, the CPU 11 receives an operation via the touch sensor 181 and does not receive an operation via the operation buttons 171. In detail, when the CPU 11 receives an operation via the operation buttons 171, the CPU 11 controls the electronic timepiece 1 such that the operation buttons 171 are enabled. When the CPU 11 does not receive an operation via the operation buttons 171, the CPU 11 controls the electronic timepiece 1 such that the operation buttons 171 are disabled. When the CPU 11 receives an operation via the touch sensor 181, the CPU 11 controls the electronic timepiece 1 such that the touch sensor 181 is enabled. When the CPU 11 does not receive an operation via the touch sensor 181, the CPU 11 controls the electronic timepiece 1 such that the touch sensor 181 is disabled. When already enabled, “enable” includes keeping it enabled. When already disable, “disable” includes keeping it disabled.

The state in which the operation buttons 171 are enabled refers to a state in which power is supplied from the battery 191 to the button operation unit 17, and the CPU 11 receives an operation signal transmitted from the button operation unit 17 to the CPU 11. That the CPU 11 receives an operation signal from the button operation unit 17 means that the CPU 11 identifies the operation button 171 on which a press operation has been performed based on the received operation signal and executes processing associated with the identified operation button 171. On the other hand, the state in which the operation buttons 171 are disabled refers to a state in which the power supply from the battery 191 to the operation buttons 171 is stopped and no operation signal is transmitted from the button operation unit 17 to the CPU 11 or a state in which the CPU 11 does not receive an operation signal from the button operation unit 17 while maintaining the power supply from the battery 191 to the button operation unit 17.

The state in which the touch sensor 181 is enabled refers to a state in which power is supplied from the battery 191 to the touch operation unit 18, and the CPU 11 receives an operation signal transmitted from the touch operation unit 18 to the CPU 11. That the CPU 11 receives an operation signal from the touch operation unit 18 means that the CPU 11 identifies contents of a touch operation (presence or absence and touch position of the touch operation) based on the received operation signal and executes processing associated with the identified contents of the touch operation. On the other hand, the state in which the touch sensor 181 is disabled refers to, for example, a state in which the touch sensor 181 is turned off. The state in which the touch sensor 181 is turned off may be, for example, a state in which the power supply from the battery 191 to the touch operation unit 18 is stopped. Alternatively, the state in which the touch sensor 181 is turned off may be a state in which the sensor controller 182 is shifted into a predetermined sleep mode (power-saving mode) while the power supply from the battery 191 to the touch operation unit 18 is maintained. The sleep mode is a mode in which the sensor controller 182 stops the operation of the touch sensor 181 and stops the main functions except for functions such as waiting for a control signal instructing a return from the sleep mode. When the touch sensor 181 is turned off, an operation signal related to a touch operation is not transmitted from the touch operation unit 18 to the CPU 11. As a result, even when a touch operation is performed, the CPU 11 does not perform processing corresponding to the touch operation, thereby rendering the touch sensor 181 disabled. The state in which the touch sensor 181 is disabled may be a state in which the CPU 11 does not receive an operation signal from the touch operation unit 18 while maintaining the power supply from the battery 191 to the touch operation unit 18 to allow the touch operation unit 18 to operate normally.

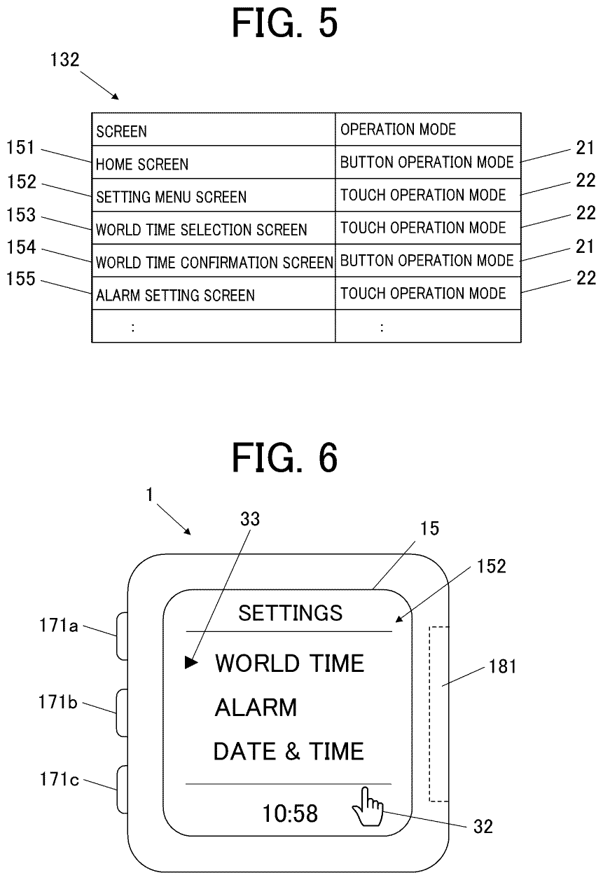

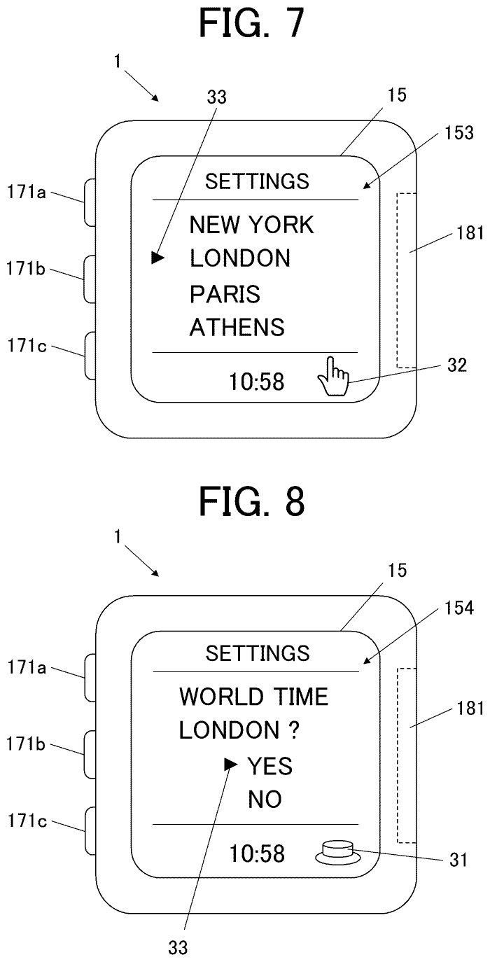

Hereinafter, an operation of the electronic timepiece 1 regarding screen transitions will be specifically described with reference to FIGS. 6 to 8. The setting menu screen 152 illustrated in FIG. 6 is a screen displayed on the display 15 when the user configures the operation settings for the electronic timepiece 1. The setting menu screen 152 is displayed, for example, by pressing predetermined one of the operation buttons 171 on the home screen 151 illustrated in FIG. 1. When switching the display from the home screen 151 to the setting menu screen 152, the CPU 11 refers to the screen setting data 132 and acquires the second setting information 22 associated with the setting menu screen 152. Accordingly, the CPU 11 operates the electronic timepiece 1 in the touch operation mode when displaying the setting menu screen 152 on the display 15. In other words, the CPU 11 controls the operation buttons 171 to be disabled and the touch sensor 181 to be enabled. As illustrated in FIG. 6, in the touch operation mode, the CPU 11 displays a touch operation indicator 32 (second indicator) on the display 15 indicating that an operation via the touch sensor 181 is possible. The touch operation indicator 32 in the present embodiment is a hand mark but is not limited to thereto. The touch operation indicator 32 may be a character, a symbol, a figure, a combination thereof, or the like. On the setting menu screen 152, in addition to the touch operation indicator 32, the names of a plurality of setting items and a cursor 33 that indicates the currently selected setting item among the plurality of setting items are displayed. The cursor 33 can be moved upward by an upward slide operation on the touch sensor 181 and can be moved downward by a downward slide operation on the touch sensor 181. The cursor 33 may be moved across two or more setting items by one slide operation depending on the slide amount of the slide operation. When the entire list of setting items cannot be displayed on one screen, the list of setting items can be scrolled up and down by slide operations. For example, when the cursor 33 is positioned on the lowest setting item among the setting items currently displayed, by performing a downward slide operation on the touch sensor 181, it is possible to scroll the list of setting items upward to reveal previously hidden items below. When the cursor 33 is positioned on the uppermost setting item among the setting items currently displayed, by performing an upward slide operation on the touch sensor 181, it is possible to scroll the list of setting items downward to reveal previously hidden items above. In FIG. 6, the cursor 33 is positioned on the “WORLD TIME” setting item, which displays the local time of a certain city in the world. When a tap operation is performed on the touch sensor 181 in this state, the screen on the display 15 is switched to the world time selection screen 153 (see FIG. 7) for selecting a city for which the local time is to be displayed.

When switching the screen to the world time selection screen 153, the CPU 11 refers to the screen setting data 132 and acquires the second setting information 22 associated with the world time selection screen 153. Accordingly, the CPU 11 maintains the electronic timepiece 1 in the touch operation mode when displaying the world time selection screen 153 on the display 15. As illustrated in FIG. 7, the CPU 11 also displays the touch operation indicator 32 on the world time selection screen 153. On the world time selection screen 153, in addition to the touch operation indicator 32, the names of a plurality of cities around the world and the cursor 33 that indicates the currently selected city among the plurality of cities are displayed. The list of cities may be scrollable up and down. In FIG. 7, the cursor 33 is positioned on the “LONDON” item. If a tap operation is performed on the touch sensor 181 in this state, the screen on the display 15 is switched to the world time confirmation screen 154 illustrated in FIG. 8.

When switching the screen to the world time confirmation screen 154, the CPU 11 refers to the screen setting data 132 and acquires the first setting information 21 associated with the world time confirmation screen 154. Accordingly, CPU 11 operates the electronic timepiece 1 in the button operation mode when displaying the world time confirmation screen 154 on the display 15. In other words, the CPU 11 controls the operation buttons 171 to be enabled and the touch sensor 181 to be disabled. As illustrated in FIG. 8, in the button operation mode, the CPU 11 displays, instead of the touch operation indicator 32, a button operation indicator 31 (first indicator) indicating that an operation via the operation buttons 171 is possible. The button operation indicator 31 in the present embodiment is a button mark but is not limited to thereto. The button operation indicator 31 may be a character, a symbol, a figure, a combination thereof, or the like. The world time confirmation screen 154 is a screen for making a final decision on the city for which the local time is to be displayed, and there are only two options available to the user: “YES” and “NO”. This is an important decision-making operation that has few options and affects the operation of electronic clock 1. Therefore, the world time confirmation screen 154 is associated with first setting information 21 indicating the button operation mode. On the world time confirmation screen 154, the cursor 33 can be moved up and down, for example, by the operation buttons 171a and 171c. In addition, by performing a press operation on the operation button 171b, it is possible to select an option on which the cursor 33 is positioned. For example, as illustrated in FIG. 8, by pressing the operation button 171b while the cursor 33 is positioned on “YES”, the city for which the local time is to be displayed can be determined to be “LONDON”. By pressing the operation button 171b while the cursor 33 is positioned on “NO”, the city selection can be canceled.

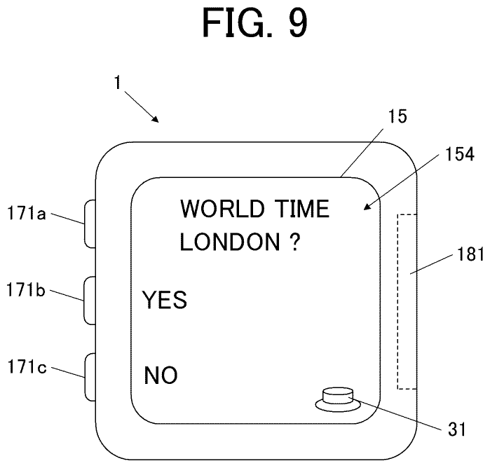

On a screen displayed in the button operation mode, when the number of options is less than or equal to the number of operation buttons 171, the options and the operation buttons 171 may be associated with each other in a one-to-one correspondence. As a result, when a certain operation button 171 is pressed, the option corresponding to that operation button 171 can be selected. For example, as illustrated in FIG. 9, on the world time confirmation screen 154, the “YES” option may be displayed at a position on the display 15 adjacent to the operation button 171b, and the “NO” option may be displayed at a position on the display 15 adjacent to the operation button 171c. This allows the operation buttons 171b and 171c to be associated with the ‘YES’ and “NO” options, respectively. In this case, pressing the operation button 171b selects “YES” to determine the city, while pressing the operation button 171c selects “NO” to cancel the city selection.

When a predetermined first switching operation is performed by the user in the touch operation mode, the CPU 11 may switch the operation mode of the electronic timepiece 1 from the touch operation mode to the button operation mode. For each screen, a screen for the touch operation mode and a screen for the button operation mode may be stored in the storage 13 in advance, and upon switching to the button operation mode, the display may be switched from the screen for the touch operation mode to the screen for the button operation mode. The first switching operation may be a predetermined operation on the touch sensor 181, for example, a special operation such as a long press operation, a double tap, or a triple tap. When the power supply to the button operation unit 17 is maintained in the touch operation mode and an operation signal can be transmitted from the button operation unit 17 to the CPU 11, the first switching operation may be a predetermined operation on a predetermined operation button 171, for example, a special operation such as a long press operation. In the touch operation mode, the CPU 11 does not receive an operation signal from the button operation unit 17. In this case, however, the CPU 11 only needs to receive an operation signal related to the first switching operation on the predetermined operation button 171. By enabling the first switching operation via the operation button 171, switching to the button operation mode can be achieved by performing the first switching operation on the operation button 171 when desired. This makes it possible to change the operation mode by an intuitive operation. When the first switching operation is performed, the CPU 11 may change the second setting information 22 associated with the currently displayed screen in the screen setting data 132 to the first setting information 21.

When a predetermined second switching operation is performed by the user in the button operation mode, the CPU 11 may switch the operation mode of the electronic timepiece 1 from the button operation mode to the touch operation mode. The CPU 11 may switch the display from the screen for the button operation mode to the screen for the touch operation mode upon switching to the touch operation mode. The second switching operation may be a predetermined operation on a predetermined operation button 171, for example, a special operation such as a long press operation. When the power supply to the touch operation unit 18 is maintained in the button operation mode and an operation signal can be transmitted from the touch operation unit 18 to the CPU 11, the second switching operation may be a predetermined operation on the touch sensor 181, for example, a special operation such as a long press operation, a double tap, or a triple tap. In the button operation mode, the CPU 11 does not receive an operation signal from the touch operation unit 18. In this case, however, the CPU 11 only needs to receive an operation signal related to the second switching operation on the touch sensor 181. By enabling the second switching operation via the touch sensor 181, switching to the touch operation mode can be achieved by performing the second switching operation on the touch sensor 181 when desired. This makes it possible to change the operation mode by an intuitive operation. When the second switching operation is performed, the CPU 11 may change the first setting information 21 associated with the currently displayed screen in the screen setting data 132 to the second setting information 22.

The touch sensor 181 consumes more power than the operation buttons 171. Therefore, when the remaining amount of power stored in the battery 191 is less than a reference amount, the electronic timepiece 1 may be operated in the button operation mode instead of the touch operation mode to extend the operable time of the electronic timepiece 1. The reference amount for the remaining power of the battery 191 may be set, for example, to 30% of the power of the battery 191 at the start of use or at the time of full charge. Additionally, as the remaining power of the battery 191 decreases, the number of screens to be operated in the touch operation mode may be reduced (in other words, the number of screens to be operated in the button operation mode may be increased).

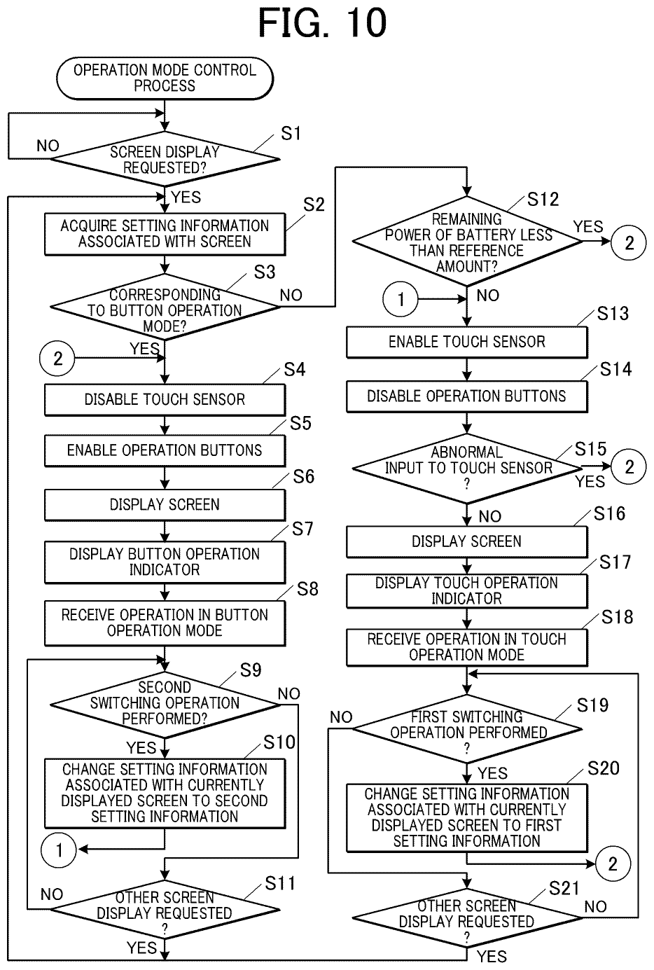

Hereinafter, an operation mode control process executed by the CPU 11 to realize the operation of the electronic timepiece 1 described above will be described with reference to a flowchart of FIG. 10. The operation mode control process is started when the electronic timepiece 1 is activated. When the operation mode control process is started, the CPU 11 repeatedly determines whether a display request for a screen different from the currently displayed screen has been made (step S1). This display request is normally made in response to a user operation. For example, when the operation button 171 for displaying the setting menu screen 152 is pressed while the home screen 151 is displayed, the CPU 11 determines that a display request for the setting menu screen 152 is made. If the CPU 11 determines that a screen display request has been made (“YES” in step S1), the CPU 11 refers to the screen setting data 132 and acquires the setting information associated with the screen for which the display request has been made (step S2).

If the CPU 11 determines that the acquired setting information is the first setting information 21 corresponding to the button operation mode (“YES” in step S3), the CPU 11 executes steps S4 to S7 to shift to the button operation mode. First, the CPU 11 executes processing to disable the touch sensor 181 (step S4). The processing may be to stop the power supply from the battery 191 to the touch operation unit 18 by transmitting a control signal to the power controller 192. The processing may also be to transmit a control signal to the sensor controller 182 to shift the sensor controller 182 into the sleep mode while maintaining the power supply to the touch operation unit 18. The processing may also be to change the operation of the CPU 11 so that the CPU 11 does not receive an operation signal transmitted from the touch operation unit 18 thereafter while maintaining the power supply to the touch operation unit 18. Next, the CPU 11 performs processing to enable the operation buttons 171 (step S5). The processing may be to start the power supply from the battery 191 to the button operation unit 17 by transmitting a control signal to the power controller 192. The processing may also be to change the operation of the CPU 11 so that the CPU 11 receives an operation signal transmitted from the button operation unit 17 thereafter while maintaining the power supply to the button operation unit 17. If the touch sensor 181 is already disabled at the point where the flow branches to “YES” in step S3, step S4 is omitted. If the operation buttons 171 are already enabled at that point, step S5 is omitted. Next, the CPU 11 transmits image data and a control signal to the display 15 to display the screen requested to be displayed in step S1 on the display 15 (step S6) and to display the button operation indicator 31 (step S7). Thereafter, the CPU 11 receives an operation in the button operation mode (step S8). In other words, according to an operation signal transmitted from the button operation unit 17, the CPU 11 identifies the operated operation button 171 and executes processing corresponding to the identified operation button 171.

The CPU 11 determines whether the second switching operation has been performed by the user (step S9). As described above, the second switching operation is normally performed on the operation button 171 but may be performed on the touch sensor 181. If the CPU 11 determines that the second switching operation has been performed (“YES” in step S9), the CPU 11 changes, in the screen setting data 132, the setting information associated with the currently displayed screen from the first setting information 21 to the second setting information 22 (step S10). The CPU 11 also advances the process to step S13 described below and executes steps S13 to S17 to shift to the touch operation mode. If the CPU 11 determines that the second switching operation has not been performed (“NO” in step S9), the CPU 11 determines whether a display request for a screen different from the currently displayed screen has been made (step S11). If the CPU 11 determines that a screen display request has not been made (“NO” in step S11), the CPU 11 returns the process to step S9. If the CPU 11 determines that a screen display request has been made (“YES” in step S11), the CPU 11 returns the process to step S2.

On the other hand, if the CPU 11 determines that the setting information acquired in step S2 is not the first setting information 21 corresponding to the button operation mode (i.e., the second setting information 22 corresponding to the touch operation mode) (“NO” in step S3), the CPU 11 acquires information on the remaining power of the battery 191 from the power controller 192 to determine whether the remaining power is less than the reference amount (step S12). If the CPU 11 determines that the remaining power of the battery 191 is less than the reference amount (“YES” in step S12), the CPU 11 advances the process to step S4 and executes steps S4 to S7 to shift to the button operation mode. If the CPU 11 determines that the remaining power of the battery 191 is equal to or more than the reference amount (“NO” in step S12), CPU 11 executes steps S13 to S17 to shift to the touch operation mode. First, the CPU 11 executes processing to enable the touch sensor 181 (step S13). The processing may be to start the power supply from the battery 191 to the touch operation unit 18 by transmitting a control signal to the power controller 192. The processing may also be to transmit a control signal to the sensor controller 182 to return the sensor controller 182 from the sleep mode while maintaining the power supply to the touch operation unit 18. The processing may also be to change the operation of the CPU 11 so that the CPU 11 receives an operation signal transmitted from the touch operation unit 18 thereafter while maintaining the power supply to the touch operation unit 18. Next, the CPU 11 executes processing to disable the operation buttons 171 (step S14). The processing may be to stop the power supply from the battery 191 to the button operation unit 17 by transmitting a control signal to the power controller 192. The processing may also be to change the operation of the CPU 11 so that the CPU 11 does not receive an operation signal transmitted from the button operation unit 17 thereafter while maintaining the power supply to the button operation unit 17. If the touch sensor 181 is already enabled at the point where the flow branches to “NO” in step S12, step S13 is omitted. If the operation buttons 171 are already disable at that point, step S14 is omitted. When the operation buttons 171 are not to be disabled in the touch operation mode, the processing to enable the operation buttons 171 (processing similar to that performed in step S5) is executed instead of step S14.

Next, the CPU 11 determines whether an abnormal input has been made to the touch sensor 181 (step S15). For example, when the electronic timepiece 1 is used in the sea, the capacitance detected by the touch sensor 181 becomes an abnormal value due to the conductive liquid (sea water) coming into contact with the operation surface 181a of the touch sensor 181. In such a case, the CPU 11 determines that an abnormal input is made to the touch sensor 181. If the CPU 11 determines that an abnormal input has been made to the touch sensor 181 (“YES” in step S15), it is not appropriate to operate the electronic timepiece 1 in the touch operation mode. Therefore, the CPU 11 advances the process to step S4 and executes steps S4 to S7 to shift to the button operation mode. If the CPU 11 determines that no abnormal input has been made to the touch sensor 181 (“NO” in step S15), the CPU 11 transmits image data and a control signal to the display 15 to display the screen requested to be displayed in step S1 on the display 15 (step S16) and to display the touch operation indicator 32 (step S17). Thereafter, the CPU 11 receives an operation in the touch operation mode (step S18). In other words, the CPU 11 identifies the presence or absence and the contact position of contact with the touch sensor 181 according to an operation signal transmitted from the touch operation unit 18 and executes processing corresponding to the identified contact position.

The CPU 11 determines whether the first switching operation has been performed by the user (step S19). As described above, the first switching operation is normally performed on the touch sensor 181 but may be performed on the operation buttons 171. If the CPU 11 determines that the first switching operation has been performed (“YES” in step S19), the CPU 11 changes, in the screen setting data 132, the setting information associated with the currently displayed screen from the second setting information 22 to the first setting information 21 (step S20). In addition. the CPU 11 advances the process to step S4 and executes steps S4 to S7 to shift to the button operation mode. If the CPU 11 determines that the first switching operation has not been performed (“NO” in step S19), the CPU 11 determines whether a display request for a screen different from the currently displayed screen has been made (step S21). If the CPU 11 determines that a screen display request has not been made (“NO” in step S21), the CPU 11 returns the process to step S19. If the CPU 11 determines that a screen display request has been made (“YES” in step S21), the CPU 11 returns the process to step S2.

As described above, the electronic timepiece 1 according to the present embodiment includes the display 15, the operation buttons 171 that detects a press operation, the touch sensor 181 that detects a touch operation, and the CPU 11. When displaying a screen on the display 15, the CPU 11 acquires the setting information related to the operation mode that has been associated with the screen in advance. When the acquired setting information is the first setting information 21 corresponding to the button operation mode in which an operation via the operation buttons 171 is received while an operation via the touch sensor 181 is not received, the CPU 11 operates the electronic timepiece 1 in the button operation mode. When the acquired setting information is the second setting information 22 corresponding to the touch operation mode in which an operation via the touch sensor 181 is received, the CPU 11 operates the electronic timepiece 1 in the touch operation mode.

In the related art, in many cases, an operation means suitable for an operation via either an operation button or a touch sensor is different depending on a screen displayed on a display of an electronic device. Therefore, in some cases, uniformly changing the available operation means based on the environment forces a user to employ an operation means unsuitable for the displayed screen, potentially compromising user convenience during operation.

In contrast, according to the present disclosure, depending on the screen to be displayed, the electronic timepiece 1 can be operated in the operation mode suitable for operation on the screen among the button operation mode and the touch operation mode. For example, when a screen for making an important decision is displayed, an operation via the operation buttons171 is received as the button operation mode, while an operation via the touch sensor 181 is not received, thereby making it less likely for an erroneous operation to occur. In addition, by receiving an operation via the touch sensor 181 as the touch operation mode on a screen with many options or a screen that allows scrolling, it is possible to shorten the operation time and reduce the effort required for operation while achieving intuitive and easy-to-understand operations. Therefore, the user convenience during operation on the displayed screen can be improved.

When the CPU 11 determines that the predetermined first switching operation is performed by the user in the touch operation mode, the CPU 11 switches the operation mode of the electronic timepiece 1 from the touch operation mode to the button operation mode. This allows the electronic timepiece 1 to operate in the button operation mode when the user desires an operation via the operation buttons 171.

When the CPU 11 determines that the first switching operation is performed while a screen is being displayed, the CPU 11 changes the second setting information 22 associated with the screen to the first setting information 21. This allows the operation mode of the electronic timepiece 1 to be set to the button operation mode desired by the user when the same screen as the currently displayed screen is displayed next time.

When the CPU 11 determines that the predetermined second switching operation is performed by the user in the button operation mode, the CPU 11 switches the operation mode of the electronic timepiece 1 from the button operation mode to the touch operation mode. This allows the electronic timepiece 1 to operate in the touch operation mode when the user desires an operation via the touch sensor 181.

When the CPU 11 determines that the second switching operation is performed while a screen is being displayed, the CPU 11 changes the first setting information 21 associated with the screen to the second setting information 22. This allows the operation mode of the electronic timepiece 1 to be set to the touch operation mode desired by the user when the same screen as the currently displayed screen is displayed next time.

The CPU 11 may control the electronic timepiece 1 such that an operation via the operation buttons 171 is not received in the touch operation mode. This prevents the use of the operation buttons 171 unsuitable for operation and allows for easy-to-understand operation by limiting the available operation means. Therefore, the operability of the electronic timepiece 1 can be improved.

In the button operation mode, the CPU 11 displays on the display 15 the button operation indicator 31 indicating that an operation via the operation buttons 171 is possible. In the touch operation mode, the CPU 11 displays on the display 15 the touch operation indicator 32 indicating that an operation via the touch sensor 181 is possible. This allows the current operating mode to be visually conveyed to the user in an easy-to-understand manner.

The electronic timepiece 1 includes the battery 191 that supplies power to at least the touch sensor 181. In a case where the CPU acquires the second setting information 22 as the setting information associated with the screen, when the remaining power of the battery 191 is less than the predetermined reference amount, the CPU 11 operates the electronic timepiece 1 in the button operation mode. This allows the operable time of the electronic timepiece 1 to be extended by reducing power consumption of the touch sensor 181 when the battery 191 has little remaining power.

According to a method for controlling the electronic timepiece 1 according to the present embodiment, the CPU 11 executes the above process to improve the user convenience during operation on a displayed screen. The storage 13 as a non-transitory computer-readable storage medium according to the present embodiment records the programs 131 that cause the CPU 11 to perform the above process. This improves the user convenience during operation on a displayed screen.

The present disclosure is not limited to the above embodiment, and various modifications are possible. For example, although the electronic timepiece 1 is exemplified as an electronic device, the electronic device is not limited thereto. The electronic device may be any device that includes a display, an operation button, and a touch sensor. For example, the electronic device may be a smartphone, a tablet terminal, a wearable device other than a wristwatch, or the like.

The touch sensor 181 provided on the side of the housing 101 is described as an example, but the present disclosure is not limited thereto. The touch sensor may be a touch screen superimposed on the display surface of the display 15.

The screen setting data 132 in which the setting information indicating the operation mode is associated with each screen does not necessarily need to be stored in the electronic timepiece 1. For example, the screen setting data 132 may be stored in an external server, and the CPU 11 may acquire the setting information of the screen setting data 132 from the server via a communication unit provided in the electronic timepiece 1.

As the method for notifying the user of the current operation mode, a method for displaying the button operation indicator 31 or the touch operation indicator 32 on the display 15 has been exemplified. However, instead of or in addition to this, the current operation mode may be notified by causing the notification unit 16 to vibrate with a vibration pattern corresponding to the operation mode or to output a notification sound with a sound pattern corresponding to the operation mode.

In the above description, an example has been disclosed in which a flash memory is used for the storage 13 as the computer-readable medium according to the present disclosure, but the present disclosure is not limited thereto. As another computer-readable medium, an information recording medium such as a hard disk drive (HDD), a solid-state drive (SSD) or a CD-ROM may be applied. A carrier wave is also applied to the present disclosure as a medium that provides data of the programs according to the present disclosure via a communication line.

The detailed configuration and the detailed operation of each component of the electronic timepiece 1 in the above embodiment can be appropriately changed without departing from the gist of the present disclosure. Although the embodiments according to the present disclosure have been described, the scope of the present disclosure is not limited to the above-described embodiments and includes the scope of the invention as described in the claims and equivalents thereof.

1. An electronic device comprising:
a display;
an operation button that detects a press operation;
a touch sensor that detects a touch operation; and
a processor, wherein
when the processor causes the display to display a screen, the processor:
acquires setting information on an operation mode that has been associated with the screen in advance;
when the acquired setting information is first setting information corresponding to a first mode in which the processor does not receive an operation via the touch sensor but receives an operation via the operation button, operates the electronic device in the first mode; and
when the acquired setting information is second setting information corresponding to a second mode in which the processor receives the operation via the touch sensor, operates the electronic device in the second mode.

2. The electronic device according to claim 1, wherein in response to a predetermined first switching operation performed by a user in the second mode, the processor switches the operation mode of the electronic device from the second mode to the first mode.

3. The electronic device according to claim 2, wherein in response to the first switching operation performed while the screen is being displayed, the processor changes the second setting information associated with the screen to the first setting information.

4. The electronic device according to claim 1, wherein in response to a predetermined second switching operation performed by a user in the first mode, the processor switches the operation mode of the electronic device from the first mode to the second mode.

5. The electronic device according to claim 4, wherein in response to the second switching operation performed while the screen is being displayed, the processor changes the first setting information associated with the screen to the second setting information.

6. The electronic device according to claim 1, wherein the processor controls the electronic device such that the electronic device does not receive the operation via the operation button in the second mode.

7. The electronic device according to claim 1, wherein in the first mode, the processor displays on the display a first operation indicator indicating that the operation via the operation button is possible, and
in the second mode, the processor displays on the display a second operation indicator indicating that the operation via the touch sensor is possible.

8. The electronic device according to claim 1, further comprising a battery that supplies power to at least the touch sensor, wherein in a case where the processor acquires the second setting information as the setting information associated with the screen, when remaining power of the battery is less than a predetermined reference amount, the processor operates the electronic device in the first mode.

9. A method for controlling an electronic device that includes:
a display;
an operation button that detects a press operation;
a touch sensor that detects a touch operation; and
a processor,
the method comprising, by the processor, when causing the display to display a screen:
acquiring setting information on an operation mode that has been associated with the screen in advance;
when the acquired setting information is first setting information corresponding to a first mode in which the processor does not receive an operation via the touch sensor but receives an operation via the operation button, operating the electronic device in the first mode; and
when the acquired setting information is second setting information corresponding to a second mode in which the processor receives the operation via the touch sensor, operating the electronic device in the second mode.

10. The method according to claim 9, further comprising, by the processor, in response to a predetermined first switching operation performed by a user in the second mode, switching the operation mode of the electronic device from the second mode to the first mode.

11. The method according to claim 10, further comprising, by the processor, in response to the first switching operation performed while the screen is being displayed, changing the second setting information associated with the screen to the first setting information.

12. The method according to claim 9, further comprising, by the processor, in response to a predetermined second switching operation performed by a user in the first mode, switching the operation mode of the electronic device from the first mode to the second mode.

13. The method according to claim 12, further comprising, by the processor, in response to the second switching operation performed while the screen is being displayed, changing the first setting information associated with the screen to the second setting information.

14. The method according to claim 9, further comprising, by the processor, controlling the electronic device such that the electronic device does not receive the operation via the operation button in the second mode.

15. A non-transitory computer-readable storage medium recording a program executable by a computer of an electronic device that includes:
a display;
an operation button that detects a press operation;
a touch sensor that detects a touch operation; and
a processor,
the program causing the processor, when the processor causes the display to display a screen:
to acquire setting information on an operation mode that has been associated with the screen in advance;
when the acquired setting information is first setting information corresponding to a first mode in which the processor does not receive an operation via the touch sensor but receives an operation via the operation button, to operate the electronic device in the first mode; and
when the acquired setting information is second setting information corresponding to a second mode in which the processor receives the operation via the touch sensor, to operate the electronic device in the second mode.

16. The storage medium according to claim 15, the program further causes the processor, in response to a predetermined first switching operation performed by a user in the second mode, to switch the operation mode of the electronic device from the second mode to the first mode.

17. The storage medium according to claim 16, the program further causes the processor, in response to the first switching operation performed while the screen is being displayed, to change the second setting information associated with the screen to the first setting information.

18. The storage medium according to claim 15, the program further causes the processor, in response to a predetermined second switching operation performed by a user in the first mode, to switch the operation mode of the electronic device from the first mode to the second mode.

19. The storage medium according to claim 18, the program further causes the processor, in response to the second switching operation performed while the screen is being displayed, to change the first setting information associated with the screen to the second setting information.

20. The storage medium according to claim 15, the program further causes the processor to control the electronic device such that the electronic device does not receive the operation via the operation button in the second mode.
